(19) United States
(12) Patent Application Publication
(10) Pub. No.: US 2014/0252086 A1
(43) Pub. Date: Sep. 11, 2014

(54) COMPLIANCE TRACKING

(71) Applicant: Dennis A Talley, Wilmington, DE (US)

(72) Inventor: Dennis A Talley, Wilmington, DE (US)

(21) Appl. No.: 14/203,247

(22) Filed: Mar. 10, 2014

Related U.S. Application Data
(60) Provisional application No. 61/775,065, filed on Mar. 8, 2013.

(51) Int. Cl. G06Q 10/06

(52) U.S. Cl. CPC G06Q 10/06398
USPC 235/376

(57) ABSTRACT

Inspection data is accessed, the inspection data including data related to an object of inspection, the object data having been scanned from a machine-readable label that is associated with the object and that uniquely identifies the object. The inspection data further includes identification data that uniquely identifies an individual, and time data that identifies a time at which the individual scanned the machine-readable label. An inspection record that identifies the object, the individual, and the time is generated based on the accessed data, and a compliance report that includes the inspection record is generated.

### FIELD

The present application relates to tracking compliance with inspection, maintenance, and service requirements.

### BACKGROUND

Regulations promulgated by federal and state governments, as well as policies enacted by private entities, require compliance with inspection schedules. Health and safety equipment, for example, must be regularly inspected, to ensure that malfunctioning equipment is identified so that it can be repaired or replaced. Similarly, corporate quality assurance efforts may involve regular inspection of products, processes, and/or facilities.

Compliance with inspection schedules is typically tracked through manual logbook entry systems, through which inspectors record information relating to their activities. A logbook user may assert in writing, for example, that a required inspection activity took place at a scheduled time, in accordance with policies and/or regulations. Logbook systems provide opportunity for fraud, however, as logbook entries may be altered or added by unscrupulous users. Furthermore, it can be difficult to verify that inspection activity recorded in a logbook actually took place. As such, there is a need for a compliance tracking system that minimizes opportunity for fraud, and that provides a means for confirming compliance with inspection requirements.

### SUMMARY

In one aspect, inspection data is accessed, the inspection data including data related to an object of inspection, the object data having been read from a label that is associated with the object and that uniquely identifies the object. The inspection data further includes identification data that uniquely identifies an individual, and time data that identifies a time at which the individual inspected the object. An inspection record that identifies the object, the individual, and the time is generated based on the accessed data, and compliance report that includes the inspection record is generated.

In another aspect, inspection data is accessed, the inspection data including data related to an object of inspection, the object data having been scanned from a machine-readable label that is associated with the object and that uniquely identifies the object. The inspection data further includes identification data that uniquely identifies an individual, and time data that identifies a time at which the individual scanned the machine-readable label. An inspection record that identifies the object, the individual, and the time is generated based on the accessed data, and a compliance report that includes the inspection record is generated.

In a further aspect, inspection data is received from a mobile device that was used by the individual to scan the object, and the inspection data is accessed in response to its being received from the mobile device. In response to accessing the inspection data, instructions are sent to the mobile device.

In yet another aspect, the inspection record is stored in a database. One or more additional inspection records are accessed from the database, and the compliance report is generated such that it includes the inspection record as well as the one or more additional inspection records.

In a further aspect, an inspection schedule is accessed and, in response to accessing the inspection schedule, a determination is made that the object requires inspection, resulting in the generation of an alert. An alert can also be generated in response to comparing the inspection report to the inspection schedule.

In another aspect, location data is accessed and, based on the location data, it is verified that the individual scanned the object data. The location data can include global positioning system (GPS) coordinates, and verifying that the individual scanned the object data can include determining that the GPS coordinates correspond to a location of the object.

Other implementations of these aspects include corresponding systems, apparatus, and computer programs, configured to perform the described techniques, encoded on computer storage devices.

The details of one or more implementations of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a diagram of an example system that can be used for compliance tracking.

FIG. 2 is a flowchart of an example process for compliance tracking.

FIG. 3 is a diagram depicting examples of the use of a compliance tracking system in the context of healthcare services.

FIG. 4 is a diagram depicting examples of the use of a compliance tracking system in the context of hospitality services.

FIG. 5 is a diagram depicting an example of the use of a compliance tracking system in the context of elevator maintenance.

FIG. 6 is a diagram depicting an example of the use of a compliance tracking system in the context of aircraft maintenance.

FIG. 7 is a diagram of an example of a computing device and of a mobile computing device that may be used to implement the described processes.

Like reference symbols in the various drawings indicate like elements.

### DETAILED DESCRIPTION

A computerized tracking system may be used to confirm compliance with inspection policies and regulations, by providing a means for verifying that recorded inspection activity actually took place. In more detail, the system may be used to provide regulatory entities with assurance that regulated entities have performed required inspections, and may be operated by a third party.

To facilitate their interaction with the tracking system, individual inspectors may be provided with mobile computing devices, such as Quick Response (“QR”) code scanners or smartphones, that are capable of scanning machine-readable labels that uniquely identify and that are affixed to, or otherwise associated with, objects of inspection. The system may be designed such that an inspector may, by entering credentials verifying his or her identity and by scanning or otherwise inputting information from a label, receive access to a website that interfaces with a tracking database in which inspection data is recorded. A QR code affixed to an object of inspection may, for example, store a uniform resource locator (URL) that is associated with the object. Alternately, or in addition, radio-frequency identification (RFID) or traditional bar codes may be used in conjunction with a smartphone application to direct the application or a browser to a URL.

In response to an inspector scanning or otherwise entering information from the label, an inspection record may be automatically generated and stored in the tracking database, the inspection record including fields identifying, among other things, the inspector, the object of inspection, and the date and/or time at which the inspector inspected the object. The record may further include location data that can be used to verify that the inspector scanned the label associated with the object at a particular location. The location data may be, for example, the GPS coordinates of the mobile device at the time the label was scanned.

The record may be further supplemented with data gathered from sensors associated with the object of inspection. The sensors may, for example, record data related to environmental or operating conditions such as temperature or humidity, and the inspector may be able to access the recorded data and to automatically provide it to the system using the mobile device. Sensors may also be used to generate data relating to the object's status or activity. Sensors may be used, for example, to monitor times at which inspected equipment is operating, or at which inspected processes are taking place.

The inspector or a supervisor of the inspector may be able to use the website to supplement the inspection record, by providing information relating to the inspection, but may be prevented from altering fields of the record that identify the inspector, the object of inspection, the date and/or time at which the inspector inspected the object, and the location at which the object was inspected. The website may also be used to provide instructions to the inspector or supervisor, or to the mobile device operated by the inspector. The website may, for example, provide the inspector with information relating to an inspection schedule or to the object of inspection, provide the inspector with a report of previous inspection activity, and/or provide the inspector with instructions for performing the inspection.

The tracking system may also generate scheduling and compliance reports that are accessible to the inspector, supervisor, and/or regulatory entity. A scheduling report may, for example, provide a supervisor with a list of inspections that need to be performed, identifying specific objects of inspection and their locations. A compliance report may, for example, include information relating to an inspection schedule, and may provide a comparison of that inspection schedule to records of inspections that are recorded in the tracking database, thereby alerting a user of the system to scheduled inspections that were not performed, or that were not performed in accordance with regulations.

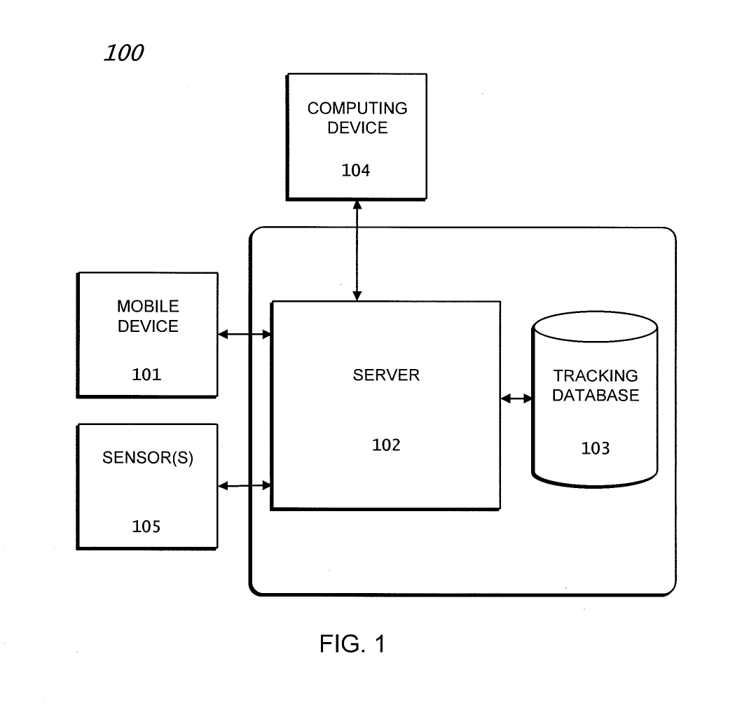

FIG. 1 is a diagram of an example system 100 that can be used for compliance tracking. The system 100 includes a mobile device 101 operated by an inspector associated with a regulated entity, a computing device 104 operated by a regulatory entity, and a server 102 and tracking database 103 operated by a third party, as well as one or more sensor(s) 105 that may generate and provide data relating to an object of inspection. Mobile device 101, computing device 104, sensor(s) 105, tracking database 103, and server 102, which operates a website, may be connected through a network, such as the Internet, with each of mobile device 101, computing device 104, and tracking database 103 interfacing with the website through the network. Sensor(s) 105 may interface with the website, or may provide data to server 102 through the network.

The server 102 operating the website may be used to access inspection data that is received from mobile device 101 and/or sensor(s) 105, the inspection data including object data, identification data, and time data. The inspection data may further include location data, operational data, and/or environmental data. The object data may have been scanned from a machine-readable label that is associated with an object of inspection, and that uniquely identifies the object of inspection. The identification data may include a user name and password that uniquely identifies the operator of the mobile device 101, and the time data may identify a time at which the individual scanned the machine-readable label using the mobile device 101. The location data may include a location of the mobile device 101 at the time at which the machine-readable label was scanned. Operational and/or environmental data accessed from sensor(s) 105 may include, for example, data relating to temperature, humidity, or any other factor that may affect the object of inspection, as well as data relating to the object of inspection itself, such as data indicating times at which the object was operational.

The operator of the mobile device 101 may receive, upon providing the inspection data to the website, instructions or other information from the website, and may submit information in addition to the inspection data using the website.

Upon accessing the inspection data from mobile device 101, the server 102 may automatically generate an inspection record that identifies the object, the operator of the mobile device 101, the time, and the location, and that may include additional information submitted by the operator of the mobile device 101 or by the sensor(s) 105. The server 102 may store the generated inspection record in the tracking database 103, and may access additional inspection records from the tracking database 103. The server 102 may generate a compliance report, and the compliance report, as well as inspection records stored in the tracking database 103, may be accessed by the operator of the mobile device 101, and/or by the operator of the computing device 104. The server 102 may further generate an alert based on a comparison of the inspection record or compliance report to an inspection schedule, and may send the alert to mobile device 101 and/or computing device 104.

The system 100 may be further configured to provide information to, and to receive information from, computing devices that are accessible to supervisors of the service, maintenance, or inspection personnel who operate mobile device 101, and/or to users of their services. The system 100 could be configured, for example, to provide real time scheduling information, so that the progress of service, maintenance, and inspection activities can be tracked. Automated electronic reminders may be provided, for example, through email or text messages to provide assurance that daily, weekly or monthly activities are being conducted on time. Similarly, a computing device that is accessible to a supervisor or customer, such as a mobile phone, personal computer, or dedicated kiosk may be configured to interact with system 100 so as to enable the supervisor or customer to enter orders for service, maintenance, or inspection.

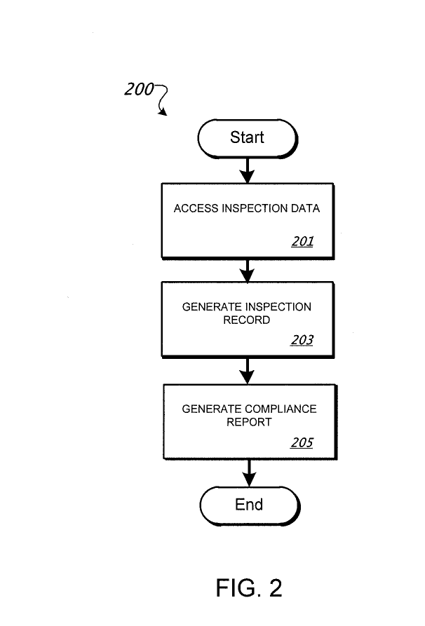

FIG. 2 is a flowchart of an example process 200 for compliance tracking. The process 200 may be implemented, for example, using system 100, although other systems or configurations may be used. In such an implementation, one or more parts of the process 200 may be executed by the server 102 operating the website, which may interface with other computers, such as mobile device 101 and computing device 104, through a network.

Process 200 begins when the server 102 accesses inspection data (201). The inspection data may include data related to an object of inspection, the object data having been scanned from a machine-readable label that is associated with the object and that uniquely identifies the object. The inspection data may also include identification data that uniquely identifies an individual, and time data that identifies a time at which the individual scanned the machine-readable label using mobile device 101. The inspection data may further include location data that identifies a location of the mobile device 101 at the time at which the machine-readable label was scanned.

Upon accessing the inspection data, the website 102 may automatically generate an inspection record that identifies the object, the operator of the mobile device 101, the time, and the location (203). The website 102 may store the generated inspection record in the tracking database 103, and may generate a compliance report that includes the inspection record (205).

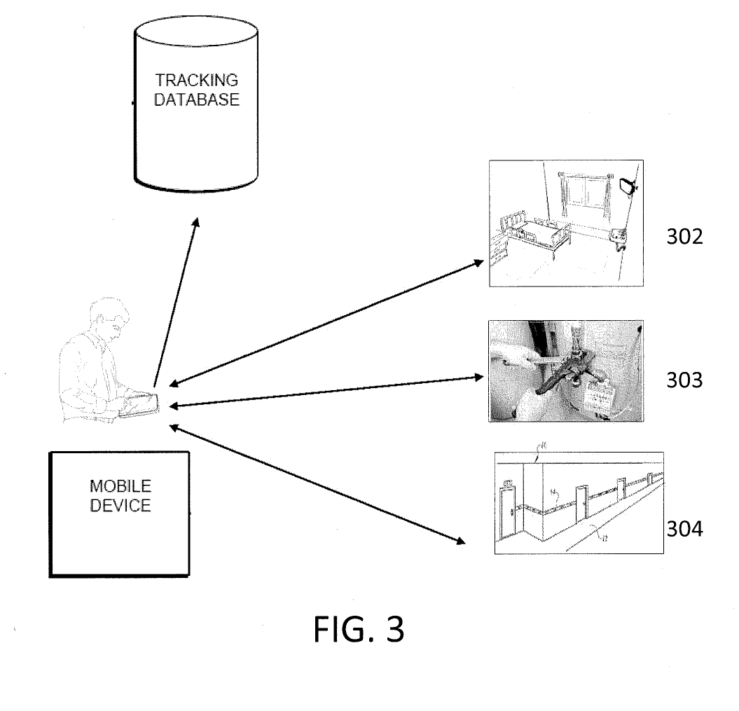

FIG. 3 is a diagram depicting examples of the use of a compliance tracking system in the context of healthcare services. The depicted compliance tracking system may be, for example, system 100, although other systems or configurations may be used.

A user of mobile device 101 may, for example, scan a machine-readable label that is located in a hospital guest room 302, in a utility room 303, or in a common area 304. A machine-readable label located in hospital guest room 302 may be scanned by a service inspector, for example, in order to generate data indicating that equipment located in the room has been inspected, or by a hospital worker in order to generator data indicating that housekeeping operations have taken place. Similarly, a safety inspector or maintenance person may scan machine-readable labels that are affixed to or otherwise associated with equipment in utility room 303 or common area 304 in order to generate data indicating that the equipment has been inspected or maintained. Equipment on which a machine-readable label may be located may include, for example, water heaters, generators, smoke detectors, sprinkler systems, fire extinguishers, exit signs and doors, and eyewash stations.

Service, maintenance, and/or inspection data that is generated by scanning a machine-readable label that is affixed to or otherwise associated with equipment and/or a location may be accessible by server 102. The generated data may include data related to an object or location, and may also include identification data that uniquely identifies an individual, and time data that identifies a time at which the individual scanned the machine-readable label using mobile device 101. Upon accessing the inspection data, the website 102 may automatically generate a service, maintenance, or inspection record that identifies the object and/or location, the operator of the mobile device 101, and the time. The website 102 may store the generated record in the secure third-party tracking database 103, and may generate a service, maintenance, or compliance report that includes the record.

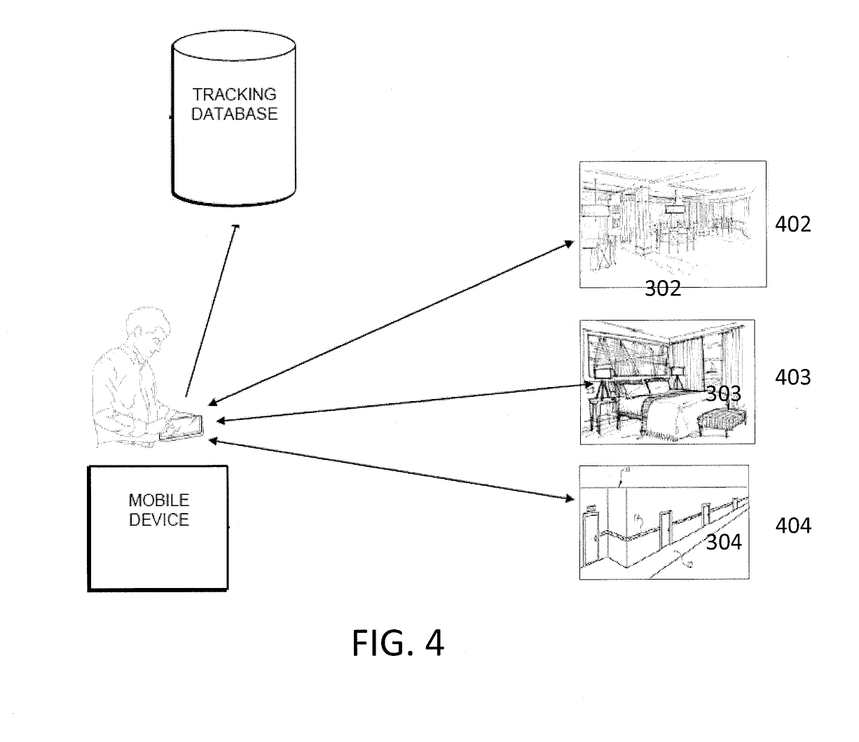

FIG. 4 is a diagram depicting examples of the use of a compliance tracking system in the context of hospitality services. The depicted compliance tracking system may be, for example, system 100, although other systems or configurations may be used.

A user of mobile device 101 may, for example, scan a machine-readable label that is located in a hotel guest room 402, in a restaurant or kitchen 403, or in a common area 404. A machine-readable label located in hotel guest room 402 may be scanned by a housekeeper, for example, in order to generate data indicating that housekeeping operations have taken place. Similarly, a health inspector may scan a machine- readable label that is located in kitchen 403 in order to generate data indicating that a health inspection has taken place, and a safety inspector may scan machine-readable labels affixed to or otherwise associated with equipment in common area 404 in order to generate data indicating that the equipment has been inspected or maintained. Equipment on which a machine-readable label may be located may include, for example, water heaters, generators, smoke detectors, sprinkler systems, fire extinguishers, exit signs and doors, and eyewash stations.

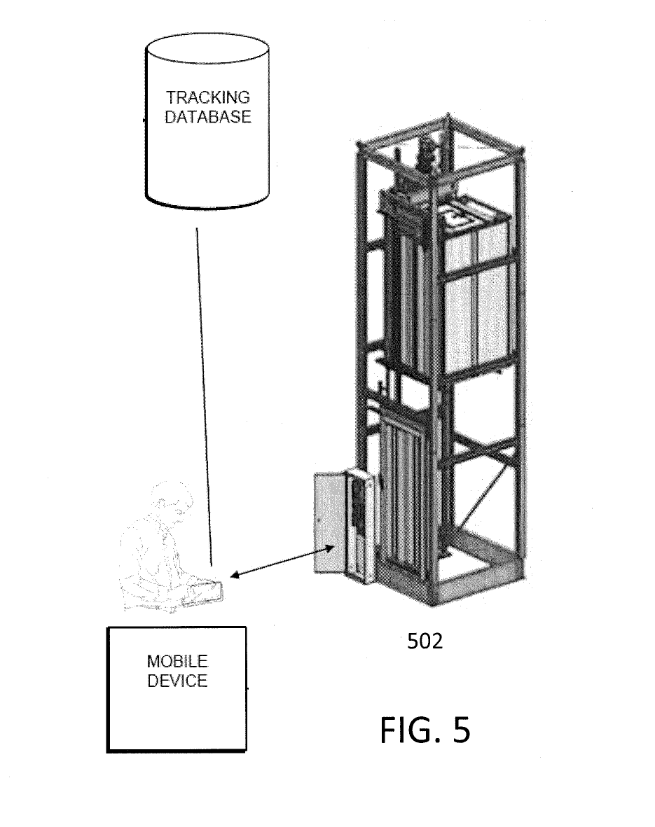

FIG. 5 is a diagram depicting an example of the use of a compliance tracking system in the context of elevator maintenance. The depicted compliance tracking system may be, for example, system 100, although other systems or configurations may be used.

A user of mobile device 101 may, for example, scan machine-readable labels that are affixed to or otherwise associated with parts of an elevator 502. Each label scanned could be associated with a different component, and could be affixed to the component in such a way that maintenance personnel would be required to perform a maintenance or inspection task in order to access the label. In a traction elevator, for example, the label could be affixed to a gearbox while in a hydraulic elevator the lavel could be affixed to a pump.

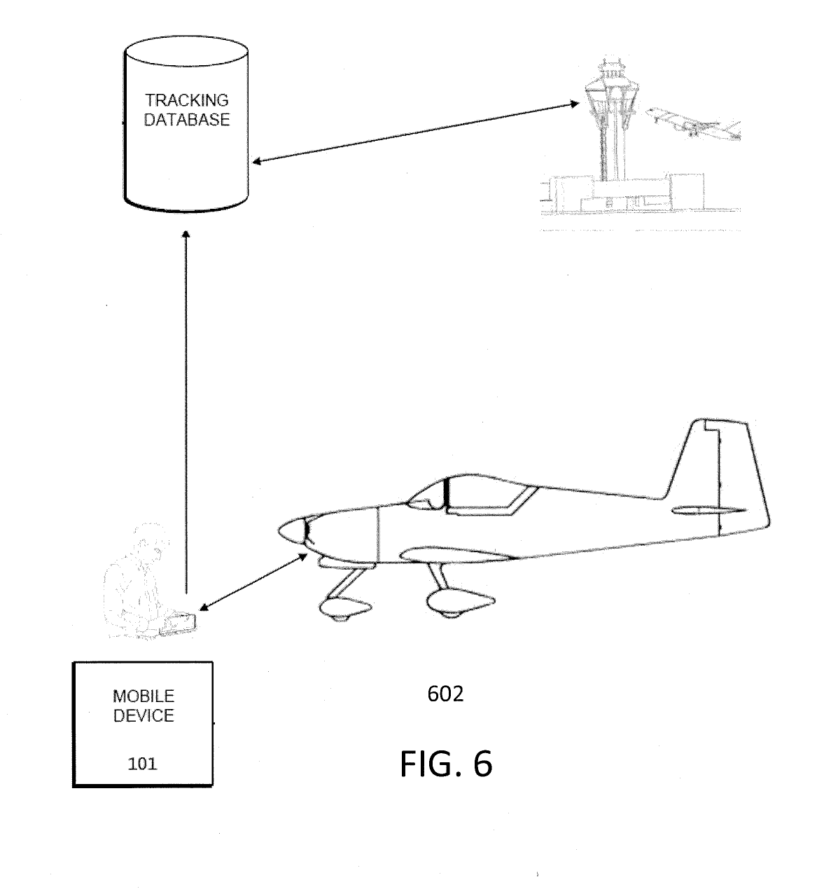

FIG. 6 is a diagram depicting an example of the use of a compliance tracking system in the context of aircraft flight operations and maintenance.

A user of mobile device 101 may, for example, scan machine-readable labels that are affixed to or otherwise associated with parts of an aircraft 602. Each label scanned could be associated with a different component of the aircraft 602, and could be affixed to the component in such a way that maintenance personnel would be required to perform a maintenance or inspection task in order to access the label. As part of a pre-flight check, for example, a mechanic may be required to access a label that is affixed to landing gear in such a way as to require proper inspection of the landing gear. The labels could be further configured such that, as each component is scanned and corresponding reports are generated and received by database 103, the reports are made available to control tower personnel, so as to allow them to track the progress of the pre-flight check.

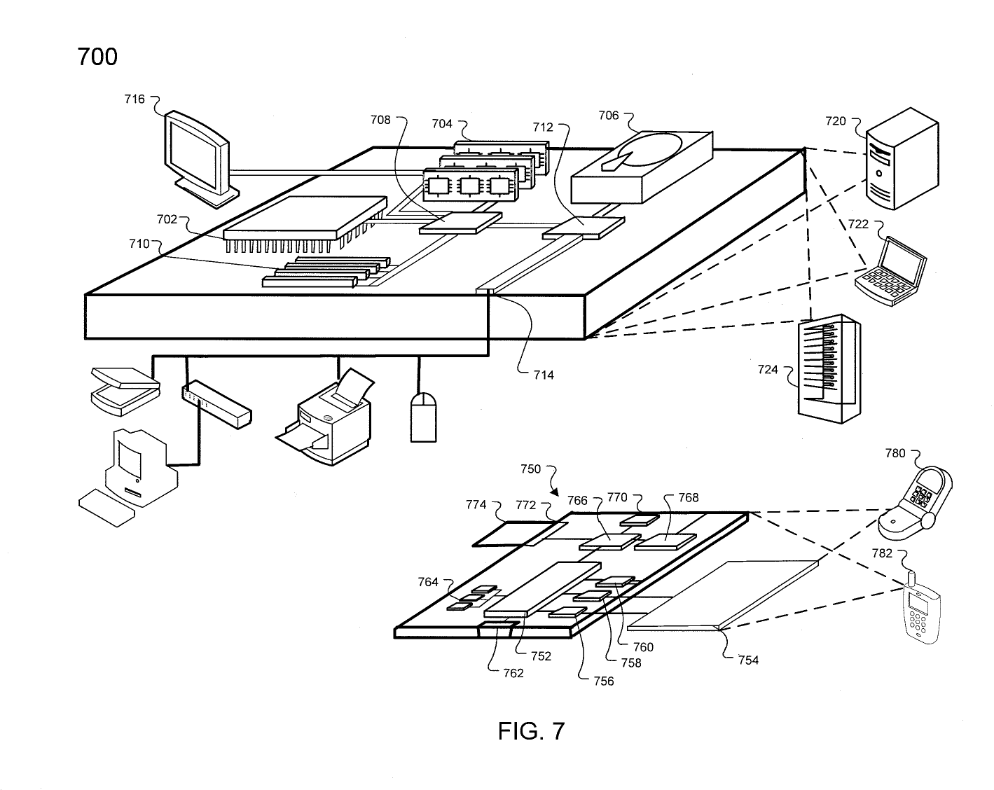

FIG. 7 is a diagram of an example of a computing device 700 and a mobile computing device 750 that may be used to implement the described processes, including client-side and server-side processes for estimating pharmaceutical product administrations. Computing device 700 is intended to represent various forms of digital computers, such as laptops, desktops, workstations, personal digital assistants, servers, blade servers, mainframes, and other appropriate computers. Computing device 750 is intended to represent various forms of mobile devices, such as personal digital assistants, cellular telephones, smartphones, QR scanners, and other similar computing devices. The components shown here, their connections and relationships, and their functions, are meant to be exemplary only, and are not meant to limit implementations of the inventions described and/or claimed in this document.

Computing device 700 includes a processor 702, memory 704, a storage device 706, a high-speed interface 708 connecting to memory 704 and high-speed expansion ports 710, and a low speed interface 712 connecting to low speed bus 714 and storage device 706. Each of the components 702, 704, 706, 708, 710, and 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as display 716 coupled to high speed interface 708. In other implementations, multiple processors and/or multiple buses may be used, as appropriate, along with multiple memories and types of memory. Also, multiple computing devices 700 may be connected, with each device providing portions of the necessary operations (e.g., as a server bank, a group of blade servers, or a multi-processor system).

The memory 704 stores information within the computing device 700. In one implementation, the memory 704 is a volatile memory unit or units. In another implementation, the memory 704 is a non-volatile memory unit or units. The memory 704 may also be another form of computer-readable medium, such as a magnetic or optical disk.

The storage device 706 is capable of providing mass storage for the computing device 700. In one implementation, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer- or machine-readable medium, such as the memory 704, the storage device 706, memory on processor 702, or a propagated signal. For example, the information carrier may be a non-transitory, machine-readable storage medium.

The high speed controller 708 manages bandwidth-intensive operations for the computing device 700, while the low speed controller 712 manages lower bandwidth-intensive operations. Such allocation of functions is exemplary only. In one implementation, the high-speed controller 708 is coupled to memory 704, display 136 (e.g., through a graphics processor or accelerator), and to high-speed expansion ports 710, which may accept various expansion cards (not shown). In the implementation, low-speed controller 712 is coupled to storage device 706 and low-speed expansion port 714. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. It may also be implemented as part of a rack server system 724. In addition, it may be implemented in a personal computer such as a laptop computer 722. Alternatively, components from computing device 700 may be combined with other components in a mobile device (not shown), such as device 750. Each of such devices may contain one or more of computing device 700, 750, and an entire system may be made up of multiple computing devices 700, 750 communicating with each other.

Computing device 750 includes a processor 752, memory 764, an input/output device such as a display 754, a communication interface 766, and a transceiver 768, among other components. The device 750 may also be provided with a storage device, such as a microdrive or other device, to provide additional storage. Each of the components 750, 752, 764, 754, 766, and 768, are interconnected using various buses, and several of the components may be mounted on a common motherboard or in other manners as appropriate.

The processor 752 can execute instructions within the computing device 750, including instructions stored in the memory 764. The processor may be implemented as a chipset of chips that include separate and multiple analog and digital processors. The processor may provide, for example, for coordination of the other components of the device 750, such as control of user interfaces, applications run by device 750, and wireless communication by device 750.

Processor 752 may communicate with a user through control interface 758 and display interface 756 coupled to a display 754. The display 754 may be, for example, a TFT LCD (Thin-Film-Transistor Liquid Crystal Display) or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may be provide in communication with processor 752, so as to enable near area communication of device 750 with other devices. External interface 762 may provide, for example, for wired communication in some implementations, or for wireless communication in other implementations, and multiple interfaces may also be used.

The memory 764 stores information within the computing device 750. The memory 764 can be implemented as one or more of a computer-readable medium or media, a volatile memory unit or units, or a non-volatile memory unit or units. Expansion memory 774 may also be provided and connected to device 750 through expansion interface 772, which may include, for example, a SIMM (Single In Line Memory Module) card interface. Such expansion memory 774 may provide extra storage space for device 750, or may also store applications or other information for device 750. Specifically, expansion memory 774 may include instructions to carry out or supplement the processes described above, and may include secure information also. Thus, for example, expansion memory 774 may be provide as a security module for device 750, and may be programmed with instructions that permit secure use of device 750. In addition, secure applications may be provided via the SIMM cards, along with additional information, such as placing identifying information on the SIMM card in a manner that is not modifiable by the end-user.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 764, expansion memory 774, memory on processor 752, or a propagated signal that may be received, for example, over transceiver 768 or external interface 762.

Device 750 may communicate wirelessly through communication interface 766, which may include digital signal processing circuitry where necessary. Communication interface 766 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 768. In addition, short-range communication may occur, such as using a Bluetooth, Wi-Fi, or other such transceiver (not shown). In addition, GPS (Global Positioning System) receiver module 770 may provide additional navigation-and location-related wireless data to device 750, which may be used as appropriate by applications running on device 750.

Device 750 may also communicate audibly using audio codec 760, which may receive spoken information from a user and convert it to usable digital information. Audio codec 760 may likewise generate audible sound for a user, such as through a speaker, e.g., in a handset of device 750. Such sound may include sound from voice telephone calls, may include recorded sound (e.g., voice messages, music files, etc.) and may also include sound generated by applications operating on device 150.

The computing device 750 may be implemented in a number of different forms, as shown in the figure. For example, it may be implemented as a cellular telephone 780. It may also be implemented as part of a smartphone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the disclosure.

In addition, logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Elements of different implementations described herein may be combined to form other implementations not specifically set forth above. Elements may be left out of the processes, computer programs, Web pages, etc. described herein without adversely affecting their operation. Furthermore, various separate elements may be combined into one or more individual elements to perform the functions described herein.

Other implementations not specifically described herein are also within the scope of the following claims.

What is claimed is:

1. A method comprising:
accessing inspection data, wherein the inspection data includes object data scanned from a machine-readable label that uniquely identifies an object associated with the machine-readable label, wherein the inspection data includes identification data that uniquely identifies an individual, and wherein the inspection data includes time data that identifies a time at which the individual uniquely identified by the identification data scanned the machine-readable label;
generating, based on the accessed data, an inspection record, wherein the inspection record identifies the object, the individual, and the time; and
generating, by one or more processors, a compliance report, wherein the compliance report includes the inspection record.

2. The method of claim 1, further comprising receiving inspection data from a mobile device, wherein the inspection data is accessed in response to receiving the inspection data from the mobile device, and wherein the individual scanned the object data using the mobile device.

3. The method of claim 2, further comprising:
responsive to accessing the inspection data, sending instructions to the mobile device.

4. The method of claim 1, further comprising:
storing the inspection record in a database; and
accessing one or more additional inspection records in the database, wherein the compliance report includes the inspection record and the one or more additional inspection records.

5. The method of claim 1, further comprising:
accessing an inspection schedule; and
responsive to accessing the inspection schedule:
determining that the object requires inspection; and
generating an alert.

6. The method of claim 1, further comprising:
comparing the inspection report to an inspection schedule; and
responsive to comparing the inspection report to the inspection schedule, generating an alert.

7. The method of claim 1, further comprising:
accessing location data; and
verifying, based on accessing the location data, that the individual scanned the object data.

8. The method of claim 7, wherein the location data includes global positioning system (GPS) coordinates, and wherein verifying that the individual scanned the object comprises determining that the GPS coordinates correspond to a location of the object.

9. The method of claim 1, wherein the inspection data includes data relating to maintenance activities.

10. A system comprising:
one or more processing devices; and
a non-transitory computer-readable medium coupled to the one or more processing devices having instructions stored thereon which, when executed by the one or more processing devices, cause the one or more processing devices to perform operations comprising:
accessing inspection data, wherein the inspection data includes object data scanned from a machine-readable label that uniquely identifies an object associated with the machine-readable label, wherein the inspection data includes identification data that uniquely identifies an individual, and wherein the inspection data includes time data that identifies a time at which the individual uniquely identified by the identification data scanned the machine-readable label;
generating, based on the accessed data, an inspection record, wherein the inspection record identifies the object, the individual, and the time; and
generating, by one or more processors, a compliance report, wherein the compliance report includes the inspection record.

11. The system of claim 10, further comprising receiving inspection data from a mobile device, wherein the inspection data is accessed in response to receiving the inspection data from the mobile device, and wherein the individual scanned the object data using the mobile device.

12. The system of claim 11, further comprising:
responsive to accessing the inspection data, sending instructions to the mobile device.

13. The system of claim 10, further comprising:
storing the inspection record in a database; and
accessing one or more additional inspection records in the database, wherein the compliance report includes the inspection record and the one or more additional inspection records.

14. The system of claim 10, further comprising:
accessing an inspection schedule; and
responsive to accessing the inspection schedule:
determining that the object requires inspection; and
generating an alert.

15. The system of claim 10, further comprising:
comparing the compliance report to an inspection schedule; and
responsive to comparing the compliance report to the inspection schedule, generating an alert.

16. The system of claim 10, further comprising:
accessing location data; and
verifying, based on accessing the location data, that the individual scanned the object data.

17. The system of claim 15, wherein the location data includes global positioning system (GPS) coordinates, and wherein verifying that the individual scanned the object comprises determining that the GPS coordinates correspond to a location of the object.

18. A computer-readable non-transitory storage medium encoded with a computer program, the program comprising instructions that when executed by one or more processors cause the one or more processors to perform operations comprising:
accessing inspection data, wherein the inspection data includes object data scanned from a machine-readable label that uniquely identifies an object associated with the machine-readable label, wherein the inspection data includes identification data that uniquely identifies an individual, and wherein the inspection data includes time data that identifies a time at which the individual uniquely identified by the identification data scanned the machine-readable label;
generating, based on the accessed data, an inspection record, wherein the inspection record identifies the object, the individual, and the time; and
generating, by one or more processors, a compliance report, wherein the compliance report includes the inspection record.

19. The computer-readable medium of claim 18, further comprising receiving inspection data from a mobile device, wherein the inspection data is accessed in response to receiving the inspection data from the mobile device, and wherein the individual scanned the object data using the mobile device.

20. The computer-readable medium of claim 19, further comprising:
responsive to accessing the inspection data, sending instructions to the mobile device.

21. The computer-readable medium of claim 19, further comprising:
storing the inspection record in a database; and
accessing one or more additional inspection records in the database, wherein the compliance report includes the inspection record and the one or more additional inspection records.

22. The computer-readable medium of claim 19, further comprising:
accessing an inspection schedule; and
responsive to accessing the inspection schedule:
determining that the object requires inspection; and
generating an alert.

23. The computer-readable medium of claim 19, further comprising:
comparing the compliance report to an inspection schedule; and
responsive to comparing the compliance report to the inspection schedule, generating an alert.

24. The computer-readable medium of claim 19, further comprising:
accessing location data; and
verifying, based on accessing the location data, that the individual scanned the object data.

25. The computer-readable medium of claim 23, wherein the location data includes global positioning system (GPS) coordinates, and wherein verifying that the individual scanned the object comprises determining that the GPS coordinates correspond to a location of the object.

26. A method comprising:
accessing inspection data, wherein the inspection data includes object data read from a label that uniquely identifies an object associated with the label, wherein the inspection data includes identification data that uniquely identifies an individual, and wherein the inspection data includes time data that identifies a time at which the individual uniquely identified by the identification data inspected the object;
generating, based on the accessed data, an inspection record, wherein the inspection record identifies the object, the individual, and the time; and
generating, by one or more processors, an inspection report, wherein the inspection report includes the inspection record.

27. The method of claim 26, wherein the label is a machine-readable label.
